(19) United States
(12) Patent Application Publication
(10) Pub. No.: US 2026/0291275 A1
(43) Pub. Date: Sep. 24, 2026

(54) ADVANCED ENERGY MANAGEMENT SYSTEMS FOR MULTIPLE PHYSICAL SITES AND METHODS THEREFOR

(71) Applicant: Next Wave Energy Monitoring, Inc., Carlsbad, CA (US)

(72) Inventors: KEVIN PHAN, Carlsbad, CA (US); NHON TRAN, Carlsbad, CA (US); ELIA YARPEZESHKAN, Carlsbad, CA (US)

(21) Appl. No.: 19/082,411

(22) Filed: Mar. 18, 2025

(51) Int. Cl. H02J 13/00

(52) U.S. Cl. CPC H02J 13/12; H02J 13/10; H02J 13/1335

(57) ABSTRACT

In general, one aspect disclosed features a computer-implemented method, comprising: monitoring multiple separate physical sites, each of the physical sites comprising at least one physical energy facility engaged in the consumption of energy; receiving, from each of the physical energy facilities, a respective parameter related to the consumption of the energy by the physical energy facility; generating a first analytic by processing parameters received from the physical energy facilities of two or more of the physical sites; generating a first user interface comprising a plurality of first display elements, wherein at least one of the first display elements depicts the first analytic; and providing the first user interface to a display device for display to a user.

### Description of Related Art

The disclosed technology relates generally to energy management, and more particularly some embodiments relate to managing energy consumption and generation across multiple physical sites.

### SUMMARY

Energy serves as a cornerstone for the thriving of any advanced civilization, acting as the lifeblood that powers economic growth, technological innovation, and societal well-being. Without a reliable and abundant energy supply, modern societies would struggle to sustain critical infrastructure or meet the demands of daily life. For instance, energy enables the operation of hospitals, where it powers life-saving medical equipment like ventilators and MRI machines. It fuels transportation networks, from electric trains whisking commuters across cities to cargo ships delivering goods globally. Additionally, energy drives industrial complexes that manufacture everything from smartphones to steel beams, and it lights homes, schools, and offices, fostering education, productivity, and comfort. These examples underscore energy's indispensable role in shaping prosperous, interconnected, and resilient communities.

However, converting raw energy into forms that society can readily use, such as electricity, heat, or mechanical power, comes at a significant cost, both financially and environmentally. The processes involved, whether mining coal, refining oil, or harnessing wind and solar power, require substantial investment in equipment, labor, and maintenance. Moreover, inefficiencies in energy systems often lead to waste, squandering resources and exacerbating environmental strain. To mitigate this, it's critical to optimize how energy is consumed and stored, ensuring that every unit of energy generated delivers maximum benefit. This could include adopting advanced technologies like smart grids to balance electricity demand or designing high-capacity batteries that store surplus renewable energy for later use. By prioritizing efficiency, societies can reduce costs, minimize ecological footprints, and stretch limited resources further, an imperative in an era of growing energy needs and finite reserves.

In many scenarios, a single enterprise, whether a corporation, university, or government entity, may oversee a network of physical facilities spread across multiple locations. Each of these sites could encompass a variety of structures, such as office buildings, warehouses, research labs, or even open land dedicated to specific purposes. Within this network, these facilities often house specialized physical energy systems tasked with generating, storing, or consuming energy to support operations. For example, a facility might feature a solar farm with sprawling photovoltaic panels that capture sunlight and convert it into electricity. Another might include a bank of electric battery systems, storing excess power generated during off-peak hours for use during high-demand periods. Elsewhere, electric vehicle charging stations might hum with activity, powering fleets of delivery trucks or employee cars. Managing these diverse energy assets effectively is a complex but essential task. Close oversight can boost efficiency, for example by scheduling battery charging during low-cost energy windows or syncing solar output with peak consumption times. Such coordination not only cuts operational costs but also enhances sustainability, aligning energy use with broader environmental and economic goals.

Energy management is the strategic oversight and optimization of energy generation, storage, consumption, and distribution to achieve efficiency, cost savings, and sustainability goals. For an enterprise operating multiple physical facilities, each potentially comprising diverse buildings, structures, and energy systems, this task becomes both more complex and more critical. Effective energy management across such a network involves integrating disparate systems, leveraging real-time data, and balancing local needs with enterprise-wide objectives. The goal is to ensure that energy resources are used judiciously, waste is minimized, and operational resilience is maintained, even as external factors like weather, market prices, or regulatory pressures fluctuate.

The payoff for mastering multi-facility energy management is substantial. Cost savings emerge from reduced energy bills and avoided waste, potentially millions of dollars annually for large organizations. Sustainability improves as fossil fuel reliance drops, aligning with corporate goals and public expectations. Operational resilience grows, too; a network of well-managed facilities can weather blackouts or price spikes better than disjointed ones.

Ultimately, energy management across multiple facilities transforms a patchwork of sites into a cohesive, efficient energy ecosystem. By leveraging technology, foresight, and cross-site synergy, enterprises can turn energy from a costly necessity into a strategic asset, driving both profitability and planetary stewardship.

In general, one aspect disclosed features a system, comprising: one or more hardware processors; and one or more non-transitory machine-readable storage media encoded with instructions that, when executed by the one or more hardware processors, cause the system to perform operations comprising: monitoring multiple separate physical sites, each of the physical sites comprising at least one physical energy facility engaged in the consumption of energy; receiving, from each of the physical energy facilities, a respective parameter related to the consumption of the energy by the physical energy facility; generating a first analytic by processing parameters received from the physical energy facilities of two or more of the physical sites; generating a first user interface comprising a plurality of first display elements, wherein at least one of the first display elements depicts the first analytic; and providing the first user interface to a display device for display to a user.

Embodiments of the system may include one or more of the following features. In some embodiments, a first one of the physical energy facilities is engaged in the production of energy, and the operations further comprise: receiving, from the first one of the physical energy facilities, a parameter related to the production of energy by the first one of the physical energy facilities; generating a second analytic by processing the parameters received from the first one of the physical energy facilities; generating a second user interface comprising a plurality of second display elements, wherein at least one of the second display elements depicts the second analytic; and providing the second user interface to the display device for display to the user.

In some embodiments, a second one of the physical energy facilities is engaged in the storage of energy, and the operations further comprise: receiving, from the second one of the physical energy facilities, a parameter related to the storage of energy by the second one of the physical energy facilities; generating a third analytic by processing the parameters received from the second one of the physical energy facilities; generating a third user interface comprising a plurality of third display elements, wherein at least one of the third display elements depicts the third analytic; and providing the third user interface to the display device for display to the user.

In some embodiments, the operations further comprise: generating a fourth analytic by processing one of the parameters, wherein the fourth analytic predicts a future value of the one of the parameters; generating a fourth user interface comprising a plurality of fourth display elements, wherein at least one of the fourth display elements depicts the fourth analytic; and providing the fourth user interface to the display device for display to the user. In some embodiments, the operations further comprise: receiving one of the parameters from a gateway connected to one of the physical energy facilities over a wireless network connection. In some embodiments, the gateway is implemented using at least one Raspberry Pi. In some embodiments, the wireless network connection is implemented as a LoRaWAN (Long Range Wide Area Network). In some embodiments, the first one of the physical energy facilities is a community solar site; the parameters received from the community solar site comprise a measure of unused energy produced by the community solar site; the second analytic represents an amount owed by a first subscriber to the community solar site; and generating the second analytic comprises processing the parameters received from the community solar site, the first subscriber's share of energy production of the community solar site, and the first subscriber's billing rate for the energy.

In general, one aspect disclosed features one or more non-transitory machine-readable storage media encoded with instructions that, when executed by one or more hardware processors of a computing system, cause the computing system to perform operations comprising: monitoring multiple separate physical sites, each of the physical sites comprising at least one physical energy facility engaged in the consumption of energy; receiving, from each of the physical energy facilities, a respective parameter related to the consumption of the energy by the physical energy facility; generating a first analytic by processing parameters received from the physical energy facilities of two or more of the physical sites; generating a first user interface comprising a plurality of first display elements, wherein at least one of the first display elements depicts the first analytic; and providing the first user interface to a display device for display to a user.

Embodiments of the one or more non-transitory machine-readable storage media may include one or more of the following features. In some embodiments, a first one of the physical energy facilities is engaged in the production of energy, and the operations further comprise: receiving, from the first one of the physical energy facilities, a parameter related to the production of energy by the first one of the physical energy facilities; generating a second analytic by processing the parameters received from the first one of the physical energy facilities; generating a second user interface comprising a plurality of second display elements, wherein at least one of the second display elements depicts the second analytic; and providing the second user interface to the display device for display to the user.

In some embodiments, a second one of the physical energy facilities is engaged in the storage of energy, and the operations further comprise: receiving, from the second one of the physical energy facilities, a parameter related to the storage of energy by the second one of the physical energy facilities; generating a third analytic by processing the parameters received from the second one of the physical energy facilities; generating a third user interface comprising a plurality of third display elements, wherein at least one of the third display elements depicts the third analytic; and providing the third user interface to the display device for display to the user.

In some embodiments, the operations further comprise: generating a fourth analytic by processing one of the parameters, wherein the fourth analytic predicts a future value of the one of the parameters; generating a fourth user interface comprising a plurality of fourth display elements, wherein at least one of the fourth display elements depicts the fourth analytic; and providing the fourth user interface to the display device for display to the user. In some embodiments, the operations further comprise: receiving one of the parameters from a gateway connected to one of the physical energy facilities over a wireless network connection.

In some embodiments, the gateway is implemented using at least one Raspberry Pi. In some embodiments, the wireless network connection is implemented as a LoRaWAN (Long Range Wide Area Network). In some embodiments, the first one of the physical energy facilities is a community solar site; the parameters received from the community solar site comprise a measure of unused energy produced by the community solar site; the second analytic represents an amount owed by a first subscriber to the community solar site; and generating the second analytic comprises processing the parameters received from the community solar site, the first subscriber's share of energy production of the community solar site, and the first subscriber's billing rate for the energy.

In general, one aspect disclosed features a computer-implemented method, comprising: monitoring multiple separate physical sites, each of the physical sites comprising at least one physical energy facility engaged in the consumption of energy; receiving, from each of the physical energy facilities, a respective parameter related to the consumption of the energy by the physical energy facility; generating a first analytic by processing parameters received from the physical energy facilities of two or more of the physical sites; generating a first user interface comprising a plurality of first display elements, wherein at least one of the first display elements depicts the first analytic; and providing the first user interface to a display device for display to a user.

Embodiments of the computer-implemented method may include one or more of the following features. In some embodiments, a first one of the physical energy facilities is engaged in the production of energy, the method further comprising: receiving, from the first one of the physical energy facilities, a parameter related to the production of energy by the first one of the physical energy facilities; generating a second analytic by processing the parameters received from the first one of the physical energy facilities; generating a second user interface comprising a plurality of second display elements, wherein at least one of the second display elements depicts the second analytic; and providing the second user interface to the display device for display to the user.

In some embodiments, a second one of the physical energy facilities is engaged in the storage of energy, the method further comprising: receiving, from the second one of the physical energy facilities, a parameter related to the storage of energy by the second one of the physical energy facilities; generating a third analytic by processing the parameters received from the second one of the physical energy facilities; generating a third user interface comprising a plurality of third display elements, wherein at least one of the third display elements depicts the third analytic; and providing the third user interface to the display device for display to the user.

Some embodiments comprise: generating a fourth analytic by processing one of the parameters, wherein the fourth analytic predicts a future value of the one of the parameters; generating a fourth user interface comprising a plurality of fourth display elements, wherein at least one of the fourth display elements depicts the fourth analytic; and providing the fourth user interface to the display device for display to the user. Some embodiments comprise: receiving one of the parameters from a gateway connected to one of the physical energy facilities over a wireless network connection. In some embodiments, the gateway is implemented using at least one Raspberry Pi. In some embodiments, the wireless network connection is implemented as a LoRaWAN (Long Range Wide Area Network). In some embodiments, the first one of the physical energy facilities is a community solar site; the parameters received from the community solar site comprise a measure of unused energy produced by the community solar site; the second analytic represents an amount owed by a first subscriber to the community solar site; and generating the second analytic comprises processing the parameters received from the community solar site, the first subscriber's share of energy production of the community solar site, and the first subscriber's billing rate for the energy.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic diagram of an advanced energy management system, according to some embodiments of the disclosed technologies.

FIG. 2 is a schematic diagram of a physical site, according to some embodiments of the disclosed technologies.

FIG. 3 is a schematic diagram of an advanced energy management system, according to some embodiments of the disclosed technologies.

FIG. 4 depicts an Overview Page user interface, according to some embodiments of the disclosed technologies.

FIG. 5 depicts an Electric Page user interface, according to some embodiments of the disclosed technologies.

FIG. 6 depicts a Lighting Page user interface, according to some embodiments of the disclosed technologies.

FIG. 7 depicts a HVAC Page user interface, according to some embodiments of the disclosed technologies.

FIG. 8 depicts a Water Page user interface, according to some embodiments of the disclosed technologies.

FIG. 9 depicts a Gas Page user interface, according to some embodiments of the disclosed technologies.

FIG. 10 depicts an Electric Vehicle (EV) Charger Page user interface, according to some embodiments of the disclosed technologies.

FIG. 11 depicts a Portfolio Page First Page user interface, according to some embodiments of the disclosed technologies.

FIG. 12 depicts a Portfolio Page Second Page user interface, according to some embodiments of the disclosed technologies.

FIG. 13 is a flowchart illustrating a process for advanced energy management, according to some embodiments of the disclosed technologies.

FIG. 14 is an example computing component that may be used to implement various features of embodiments described in the present disclosure.

The figures are not exhaustive and do not limit the present disclosure to the precise form disclosed.

### DETAILED DESCRIPTION

Embodiments of the disclosure provide advanced energy management systems and methods. These systems and methods accommodate management of energy systems across multiple physical sites, each of which may include one or more physical energy facilities including facilities for the generation, management, and storage of energy. The advanced energy management system is a comprehensive platform designed to optimize energy production, consumption, and distribution across diverse assets, from renewable energy systems to smart building infrastructure.

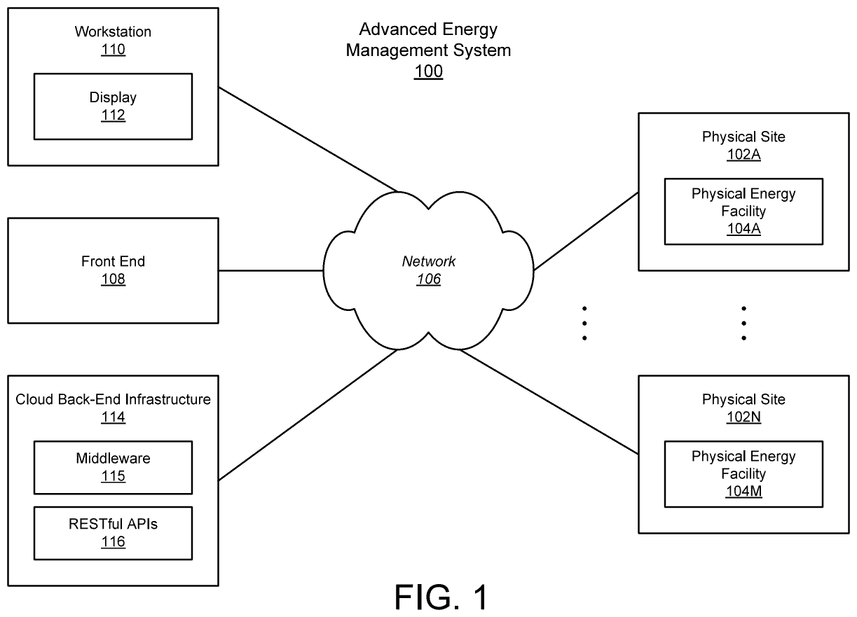

FIG. 1 is a schematic diagram of an advanced energy management system 100, according to some embodiments of the disclosed technologies. Referring to FIG. 1, the advanced energy management system 100 may include multiple physical sites 102A-N. Each physical site 102 may include one or more physical energy facilities 104A-M. A physical site 102 may be a building, structure, or area where a physical energy facility 104 is deployed. For example, a physical site 102 may be a plot of land where a solar farm is implemented.

The advanced energy management system 100 may include a front end 108 and cloud back-end infrastructure 114, each of which may implement one or more applications. Each of the front end 108 and cloud back-end infrastructure 114 may be implemented as one or more computing systems, for example such as those described below.

The front end 108 may be implemented as a Web-based portal. The portal may be implemented using React for real-time visualization and user interaction. React is a robust and versatile JavaScript library widely adopted for crafting user interfaces, especially in single-page applications. Its component-driven structure enables developers to design reusable UI components, making it an ideal option for constructing dashboards.

The cloud back-end infrastructure 114 may host middleware 115, and may include one or more application programming interfaces (APIs) for exchanging data with the physical sites 102 and/or physical energy facilities 104. The APIs may be implemented as a Representational State Transfer (RESTful) API for device communication and third-party integration. A RESTful API is a set of rules that allows applications to communicate with each other over the Internet.

The back end may be implemented using Java Spring Boot for business logic, data processing, and API management. Spring Boot is an open-source, Java-based framework that simplifies the development of production-ready applications. Spring Boot is built on top of the popular Spring framework and is designed to reduce boilerplate code, making it faster and easier to create standalone, enterprise-grade applications. The cloud infrastructure provides scalable cloud hosting with dynamic resource allocation and load balancing.

The advanced energy management system 100 may include one or more workstations 110. Operational personnel may employ the workstations 110 to control the advanced energy management system 100. Each workstation 110 may include a display 112, as well as other input/output devices. Each workstation 110 may be implemented as one or more computing systems, for example such as those described below.

The front end 108, cloud back-end infrastructure 114, workstation(s) 110, and physical site(s) 102 may be connected by one or more communication networks 106.

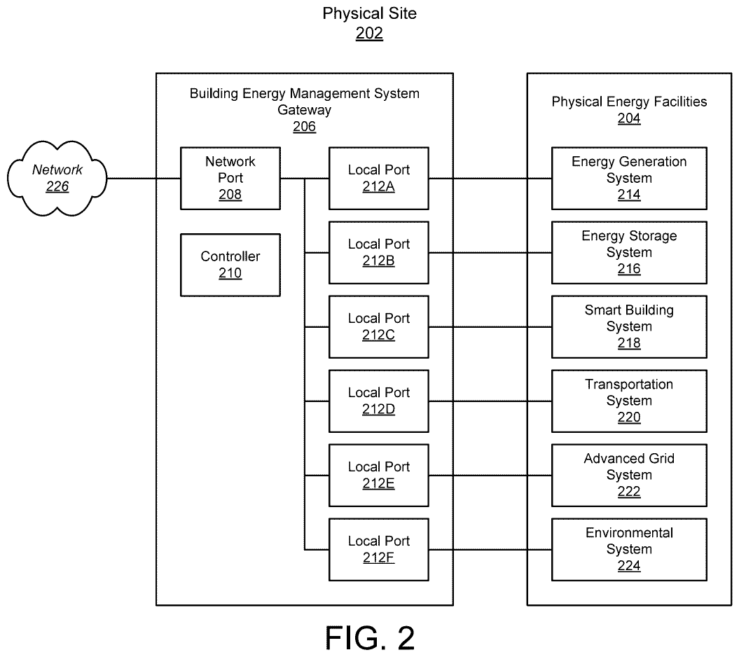

FIG. 2 is a schematic diagram of a physical site 202, according to some embodiments of the disclosed technologies. Referring to FIG. 2, the physical site 202 may include one or more physical energy facilities 204. In the example of FIG. 2, the physical energy facilities 204 include an energy generation system 214. For example, the energy generation system 214 may include assets such as, but not limited to, solar PV, wind turbines, fusion power, space-based solar arrays, and piezoelectric harvesters. The implementation of the solar PV may include monitoring parameters and generating analytics. The parameters may include real-time metrics, inverter tracking, fault detection, and similar parameters. The analytics may include weather correlation, historical performance, string-level diagnostics, and similar analytics.

The physical energy facilities 204 may include an energy storage system 216. For example, the energy storage systems 216 may include assets such as, but not limited to, quantum batteries, bio-organic storage, gravity-based systems, and supercapacitors.

The physical energy facilities 204 may include a smart building system 218. For example, the smart building system 218 may include assets such as, but not limited to, self-healing materials, neural building networks, and biomimetic climate control.

The physical energy facilities 204 may include a transportation system 220. For example, the transportation system 220 may include assets such as, but not limited to, flying vehicle charging, hyperloop power management, and wireless power roads.

The physical energy facilities 204 may include an advanced grid system 222. For example, the advanced grid system 222 may include assets such as, but not limited to, quantum grid controllers, zero-point energy extractors, and molecular transmission lines.

The physical energy facilities 204 may include an environmental system 224. For example, the environmental system 224 may include assets such as, but not limited to, atmospheric water generators, waste-to-energy converters, and carbon capture units.

The physical site 202 may include a building energy management system gateway 206. In some embodiments, the building energy management system gateway 206 may be implemented using at least one Raspberry Pi. The building energy management system gateway 206 may include a controller 210, a network port 208, and one or more local ports 212A-F. Each local port 212 may provide communications between the building energy management system gateway 206 and one of the physical energy facilities 204. The network port 208 may provide communications between the building energy management system gateway 206 and a network 226. The network 226 may provide communications with other components of the advanced energy management system 100. The controller 210 may control the network port 208 and the local ports 212.

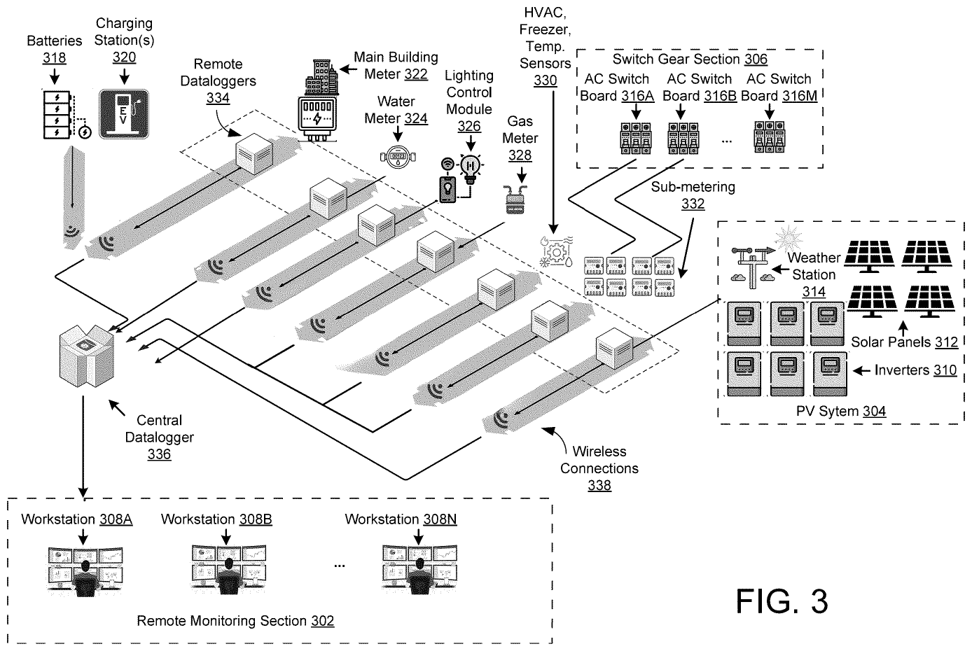

FIG. 3 is a schematic diagram of an advanced energy management system 300, according to some embodiments of the disclosed technologies. Referring to FIG. 3, the advanced energy management system 300 may include a remote monitoring section 302. The remote monitoring section 302 may include one or more workstations 308A-N for operators to observe and manage components of the advanced energy management system 300.

The advanced energy management system 300 may include a photovoltaic (PV) system 304. The PV system 304 may include one or more inverters 310, one or more solar panels 312, one or more weather stations 314, PV meters, and similar components. The solar panels 312 may generate direct-current (DC) power from sunlight. The inverters 310 may convert the DC power to alternating current (AC) power. The weather station(s) 314 may provide information describing weather conditions at the location(s) of the solar panels 312 for use in controlling their operation.

The advanced energy management system 300 may include a switch gear section 306. The switch gear section 306 may include one or more AC switch boards 316A-M. The AC switch boards 316A-M may manage the AC output of the inverters 310, and may distribute that output to other parts of the system 300. The AC switch boards 316A-M may also ensure safe operation by isolating faults (e.g., short circuits), controlling power flow, and protecting equipment. For example, if a fault occurs in one inverter string, the switchboard can disconnect that section while keeping the rest of the system operational. The AC switch boards 316A-M may also act as the interface between the PV system 304 and the grid or onsite storage, such as batteries 318.

The advanced energy management system 300 may include a variety of modules and sensors for monitoring and controlling components of the advanced energy management system 300.

These modules and sensors may include, but are not limited to, electric batteries 318, electric vehicle charging stations 320, main building meters 322, water meters 324, lighting control modules 326, gas meters 328, sensors 330 for heating, ventilation, and air conditioning (HVAC), freezers, temperature, and the like, and sub-metering 332 of the AC switch boards 316.

Data collected from these components may be collected by one or more remote dataloggers 334, and may be relayed to a central datalogger 336 by wireless connections 338. The wireless connections 338 may be implemented as Long Range Wide Area Network (LoRaWAN or LoRa) connections, which typically have a range of 5-10 miles. Operators may use workstations 308 to access the data logged by the central datalogger 336.

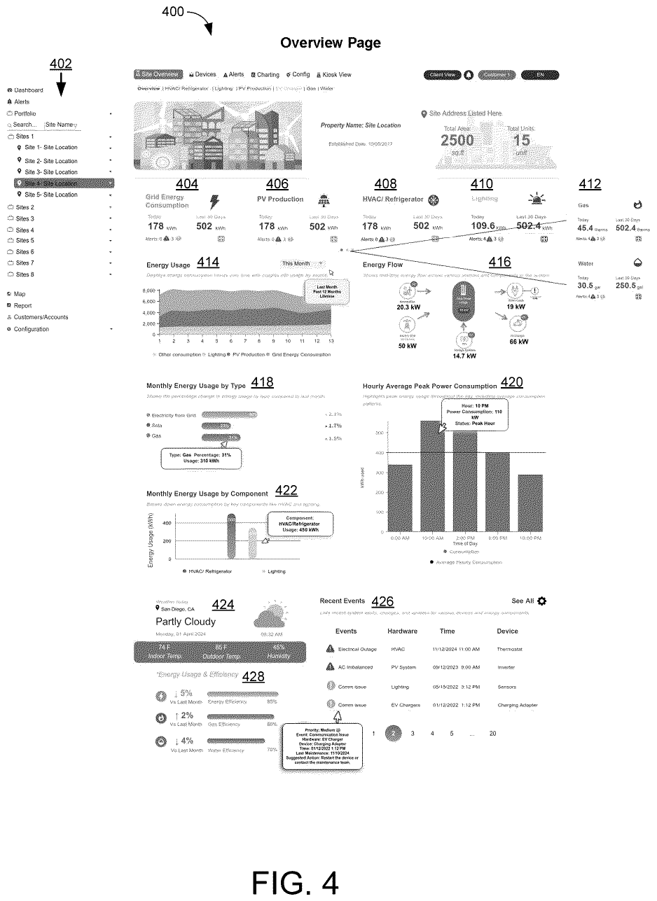

FIGS. 4-12 depict user interfaces for the disclosed advanced energy management systems, according to some embodiments of the disclosed technologies. The user interfaces may be presented on the display 112 of the workstation 110 of the advanced energy management system 100 of FIG. 1. The user interfaces may be presented on the displays of the workstations 308 of the advanced energy management system 300 of FIG. 3.

FIG. 4 depicts an Overview Page user interface 400, according to some embodiments of the disclosed technologies. The Overview Page user interface 400 includes multiple display elements. The display elements may include status display elements that indicate the values of parameters collected from components of the system, as well as the values of analytics generated by the system based on those parameters. The display elements may include control elements that enable an operator to control components of the system.

The Overview Page user interface 400 may be used to monitor and/or control system components at multiple site locations (i.e., physical sites). The depicted Overview Page user interface 400 is for Site 4, as shown at 402.

The Overview Page user interface 400 may include display elements reflecting energy consumption and efficiency of the site. In the example of FIG. 4, these display elements include Grid Energy Consumption 404, HVAC/Refrigerator 408, Lighting 410, overall Energy Usage 414, Energy Flow 416, Monthly Energy Usage by Type 418, Hourly Average Peak Power Consumption 420, Monthly Energy Usage by Component 422, and Energy Usage and Efficiency 428.

The Overview Page user interface 400 may include display elements reflecting energy production of the site. In the example of FIG. 4, these display elements include PV Production 406.

The Overview Page user interface 400 may include display elements reflecting weather conditions at the site, at 424.

The Overview Page user interface 400 may include display elements showing recent events at the site, at 426. An operator may mouse over a display element to obtain more detail. For example, more detail is shown for one of the recent events.

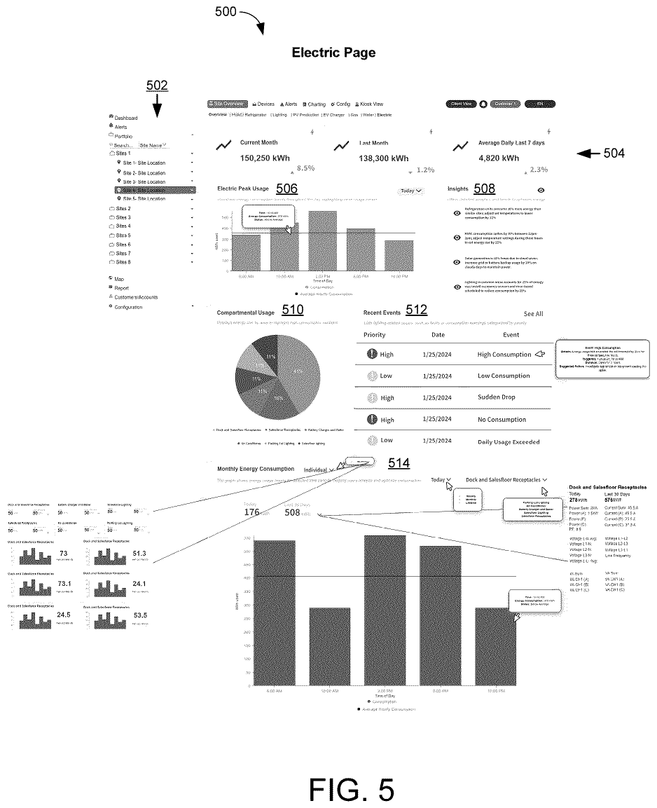

FIG. 5 depicts an Electric Page user interface 500, according to some embodiments of the disclosed technologies. The Electric Page user interface 500 includes multiple display elements. The display elements may include status display elements that indicate the values of parameters collected from electric components of the system, as well as the values of analytics generated by the system based on those parameters. The display elements may include control elements that enable an operator to control electric components of the system.

The Electric Page user interface 500 may be used to monitor and/or control system components at multiple site locations (i.e., physical sites). The depicted Electric Page user interface 500 is for Site 4, as shown at 502.

The Electric Page user interface 500 may include display elements reflecting energy consumption of the site. In the example of FIG. 5, these display elements reflect electric energy consumption for the current month, last month, and seven-day average, at 504. The display elements also include Electric Peak Usage 506, Compartmental Usage 510, and Monthly energy consumption 514.

The Electric Page user interface 500 may include display elements reflecting Insights 508 gleaned from the electric energy parameters and/or analytics. For example, one of the insights indicates that the refrigeration units at this site (Site 4) consume 18% more energy than those at similar sites, and suggests adjusting set temperatures to lower energy consumption by 12%.

The Electric Page user interface 500 may include display elements showing recent events at the site, at 512. An operator may mouse over a display element to obtain more detail. For example, more detail is shown for one of the recent events.

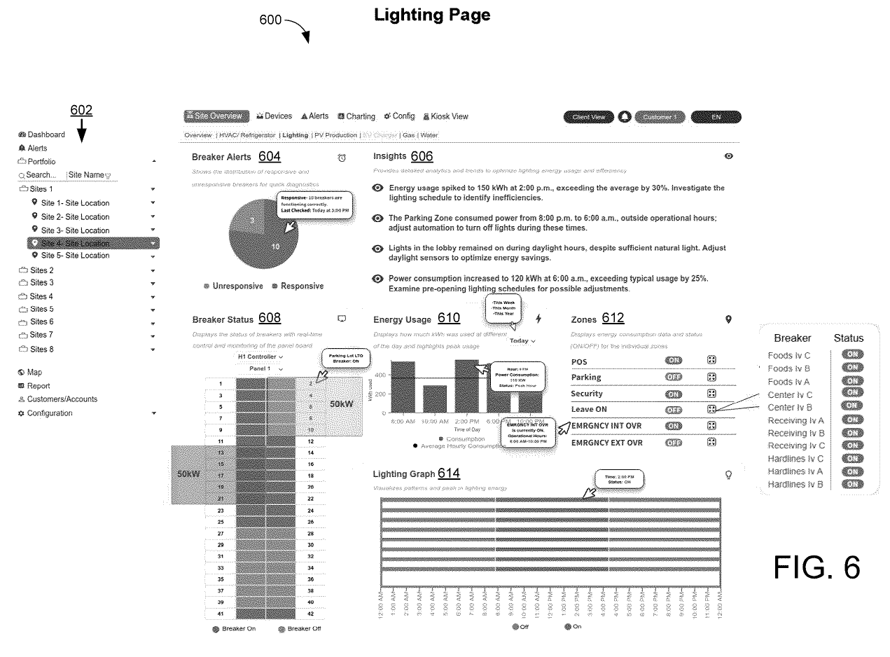

FIG. 6 depicts a Lighting Page user interface 600, according to some embodiments of the disclosed technologies. The Lighting Page user interface 600 includes multiple display elements. The display elements may include status display elements that indicate the values of parameters collected from lighting components of the system, as well as the values of analytics generated by the system based on those parameters. The display elements may include control elements that enable an operator to control lighting components of the system.

The Lighting Page user interface 600 may be used to monitor and/or control system components at multiple site locations (i.e., physical sites). The depicted Lighting Page user interface 600 is for Site 4, as shown at 602.

The Lighting Page user interface 600 may include display elements reflecting Breaker Alerts 604, Breaker Status 608, Energy Usage 610 by time period, energy usage by Zones 612, and Lighting Graphs 614.

The Lighting Page user interface 600 may include display elements reflecting Insights 608 gleaned from the lighting parameters and/or analytics. For example, one of the insights indicates that lights in the lobby remained on during daylight hours, despite sufficient natural light, and suggests adjustments to optimize energy savings. An operator may mouse over a display element to obtain more detail. For example, more detail is shown for the Breaker Alerts 604.

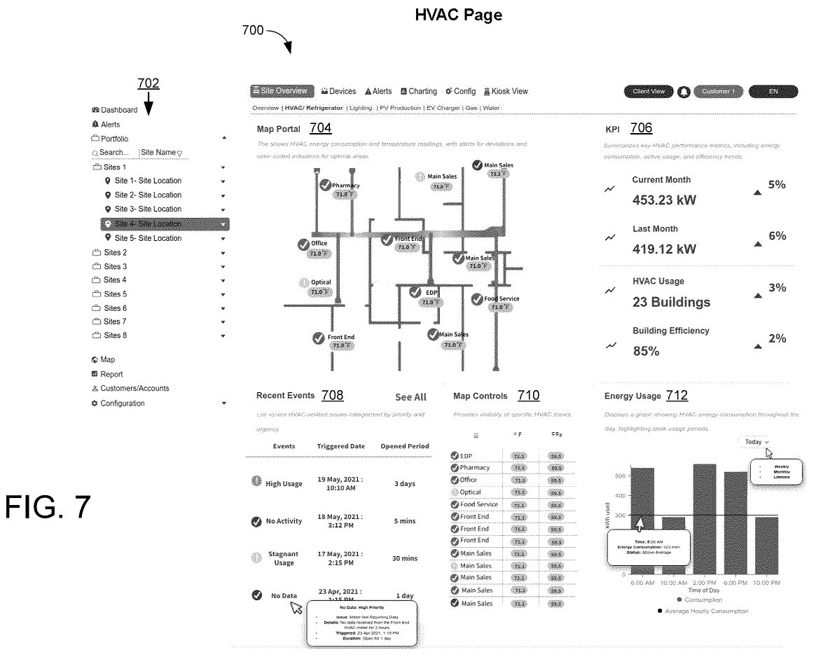

FIG. 7 depicts a HVAC Page user interface 700, according to some embodiments of the disclosed technologies. The HVAC Page user interface 700 includes multiple display elements. The display elements may include status display elements that indicate the values of parameters collected from HVAC components of the system, as well as the values of analytics generated by the system based on those parameters. The display elements may include control elements that enable an operator to control HVAC components of the system.

The HVAC Page user interface 700 may be used to monitor and/or control system components at multiple site locations (i.e., physical sites). The depicted HVAC Page user interface 700 is for Site 4, as shown at 702.

The HVAC Page user interface 700 may include display elements reflecting a Map Portal 704. The Map Portal 704 may show HVAC energy consumption and temperature readings. The Map Portal 704 may include alerts for deviations and color-coded indicators for optimal areas.

The HVAC Page user interface 700 may include display elements reflecting Key Performance Indicators (KPIs), at 706. The KPIs 706 summarize key HVAC performance metrics, including energy consumption, active usage, and efficiency trends. In the example of FIG. 7, the KPIs currently displayed include HVAC energy consumption levels and trends for the current month and last month, as well as the level and trend for building HVAC efficiency.

The HVAC Page user interface 700 may include display elements for Map Controls 710, which provide metrics for particular HVAC zones. The HVAC Page user interface 700 may include display elements indicating Energy Usage throughout the day, at 712.

The HVAC Page user interface 700 may include display elements showing recent events at the site, at 708. An operator may mouse over a display element to obtain more detail. For example, more detail is shown for one of the recent events.

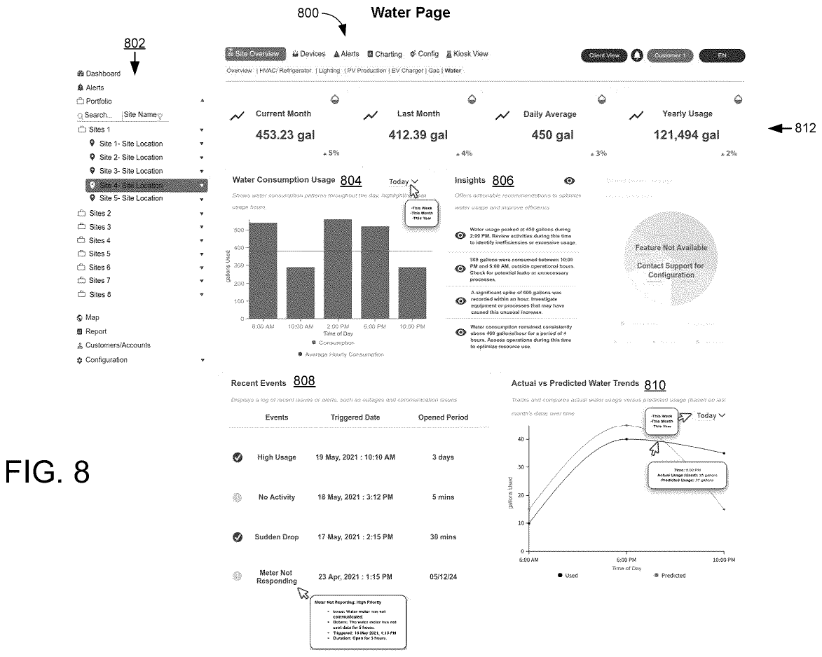

FIG. 8 depicts a Water Page user interface 800, according to some embodiments of the disclosed technologies. The Water Page user interface 800 includes multiple display elements. The display elements may include status display elements that indicate the values of parameters collected from water components of the system, as well as the values of analytics generated by the system based on those parameters. The display elements may include control elements that enable an operator to control water components of the system.

The Water Page user interface 800 may be used to monitor and/or control system components at multiple site locations (i.e., physical sites). The depicted Water Page user interface 800 is for Site 4, as shown at 802.

The Water Page user interface 800 may include display elements reflecting water consumption of the site. In the example of FIG. 8, these display elements reflect water consumption for the current month, last month, daily average, and yearly usage, at 812. The display elements may reflect water consumption patterns throughout the day, and may highlight peak usage hours, at 804. The display elements may track and compare actual water usage vs. predicted water usage over time, at 810. The predicted water usage may be based on the last month's actual water usage.

The Water Page user interface 800 may include display elements reflecting Insights 806 gleaned from the water energy parameters and/or analytics. For example, one of the insights indicates that 300 gallons of water were consumed outside operational hours, and suggests checking for leaks or unnecessary processes.

The Water Page user interface 800 may include display elements showing recent events at the site, at 808. An operator may mouse over a display element to obtain more detail. For example, more detail is shown for one of the recent events.

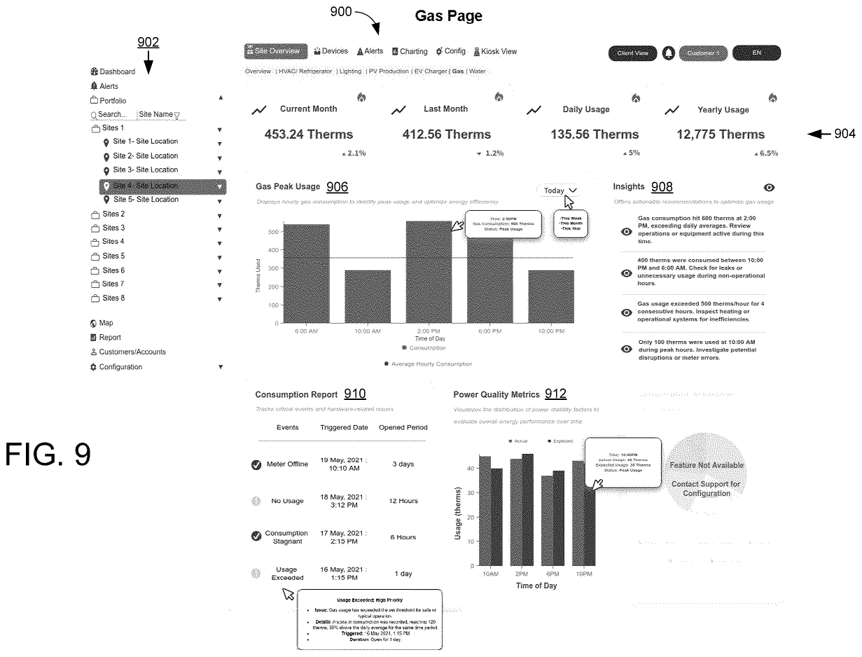

FIG. 9 depicts a Gas Page user interface 900, according to some embodiments of the disclosed technologies. The Gas Page user interface 900 includes multiple display elements. The display elements may include status display elements that indicate the values of parameters collected from gas components of the system, as well as the values of analytics generated by the system based on those parameters. The display elements may include control elements that enable an operator to control gas components of the system.

The Gas Page user interface 900 may be used to monitor and/or control system components at multiple site locations (i.e., physical sites). The depicted Gas Page user interface 900 is for Site 4, as shown at 902.

The Gas Page user interface 900 may include display elements reflecting gas consumption of the site. In the example of FIG. 9, these display elements reflect gas consumption for the current month, last month, daily average, and yearly usage, at 904. The display elements may reflect gas consumption patterns throughout the day, and may highlight peak usage hours, at 906. The display elements may provide Power Quality Metrics, at 912. The Power Quality Metrics 912 may include a visualization of the distribution of power stability factors to evaluate overall energy performance over time.

The Gas Page user interface 900 may include display elements reflecting Insights 908 gleaned from the gas energy parameters and/or analytics. For example, one of the insights indicates that 400 therms of gas were consumed outside operational hours, and suggests checking for leaks or unnecessary usage.

The Gas Page user interface 900 may include display elements showing recent events at the site, at Consumption Report 910. The Consumption Report 910 may track critical events and hardware-related issues. An operator may mouse over a display element to obtain more detail. For example, more detail is shown for one of the recent events.

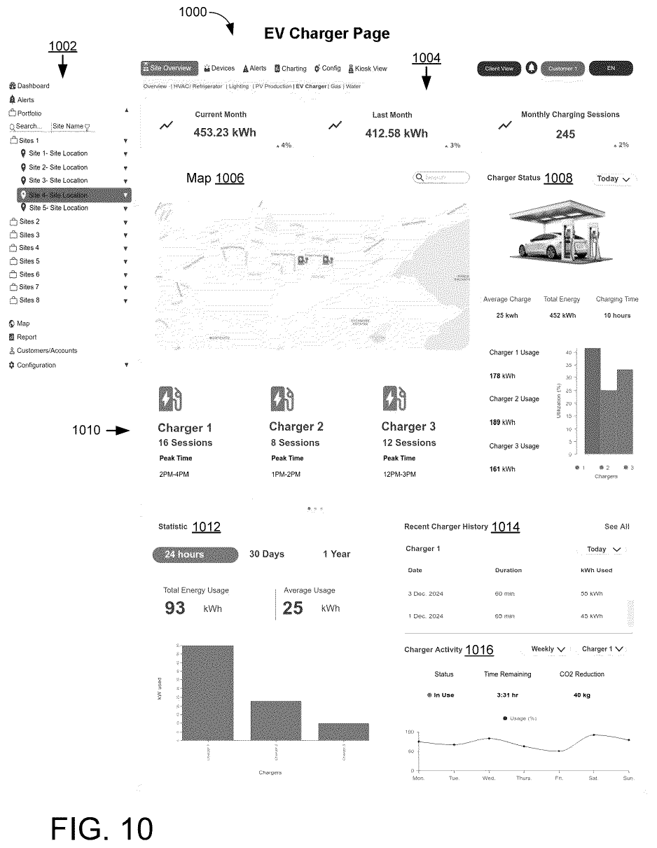

FIG. 10 depicts an Electric Vehicle (EV) Charger Page user interface 1000, according to some embodiments of the disclosed technologies. The EV Charger Page user interface 1000 includes multiple display elements. The display elements may include status display elements that indicate the values of parameters collected from EV charger components of the system, as well as the values of analytics generated by the system based on those parameters. The display elements may include control elements that enable an operator to control EV charger components of the system.

The EV Charger Page user interface 1000 may be used to monitor and/or control system components at multiple site locations (i.e., physical sites). The depicted EV Charger Page user interface 1000 is for Site 4, as shown at 1002.

The EV Charger Page user interface 1000 may include display elements reflecting power consumption of the site. In the example of FIG. 9, these display elements reflect power consumption for the current month and last month, as well as the number of charging sessions per month, at 1004.

The EV Charger Page user interface 1000 may include display elements for a Map 1006. The Map 1006 may indicate locations of EV Charger stations associated with the site.

The EV Charger Page user interface 1000 may include display elements indicating Charger Status, at 1008. The Charger Status 1008 may indicate the average charge, total energy consumed, and charging time for the chargers, as well as power usage per charger, for a selected day.

The EV Charger Page user interface 1000 may include display elements indicating the number of charging sessions and peak charging time for each charger, at 1010.

The EV Charger Page user interface 1000 may include display elements indicating Statistics 1012 for the chargers over a selected period such as the last 24 hours, last 30 days, and last year. The Statistics 1012 may include total energy usage and average usage for all chargers, as well as energy usage per charger.

The EV Charger Page user interface 1000 may include display elements indicating Recent Charger History 1014. The Recent Charger History 1014 may list individual charging sessions for a selected charger for a selected period, including date, charging session duration, and energy used in the session.

The EV Charger Page user interface 1000 may include display elements indicating Charger Activity 1016. The Charger Activity 1016 may list, for a selected charger and time period, a usage status, a time remaining in a current charging session, and carbon dioxide reduction for the charging session.

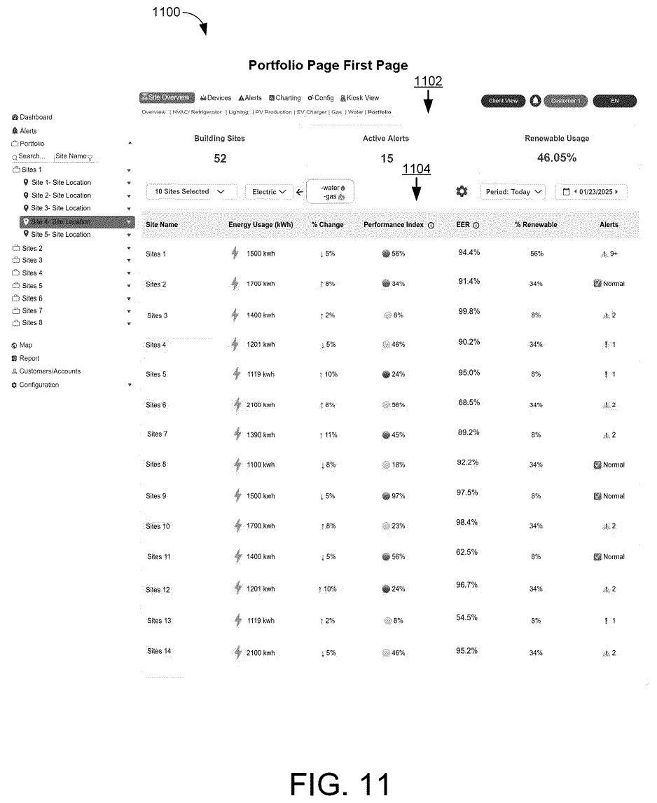

FIG. 11 depicts a Portfolio Page First Page user interface 1100, according to some embodiments of the disclosed technologies. The Portfolio Page First Page user interface 1100 includes multiple display elements. The display elements may include status display elements that indicate the values of parameters collected from multiple sites of the system, as well as the values of analytics generated by the system based on those parameters. The display elements may include control elements that enable an operator to control components of the system at multiple sites. In the example of FIG. 11, the sites include Sites 1-14.

The Portfolio Page First Page user interface 1100 may include display elements reflecting parameters and analytics aggregated for the multiple sites, at 1102. In the example of FIG. 11, these aggregated parameters and analytics include the number of building sites, the number of active alerts, and renewable energy usage as a percentage of total energy usage.

The Portfolio Page First Page user interface 1100 may include display elements reflecting parameters and analytics for individual sites, at 1104. In the example of FIG. 11, these parameters and analytics include site name, energy usage, percent change in energy usage, performance index, energy efficiency ratio (EER), renewable energy usage as a percentage of total energy usage, and alerts.

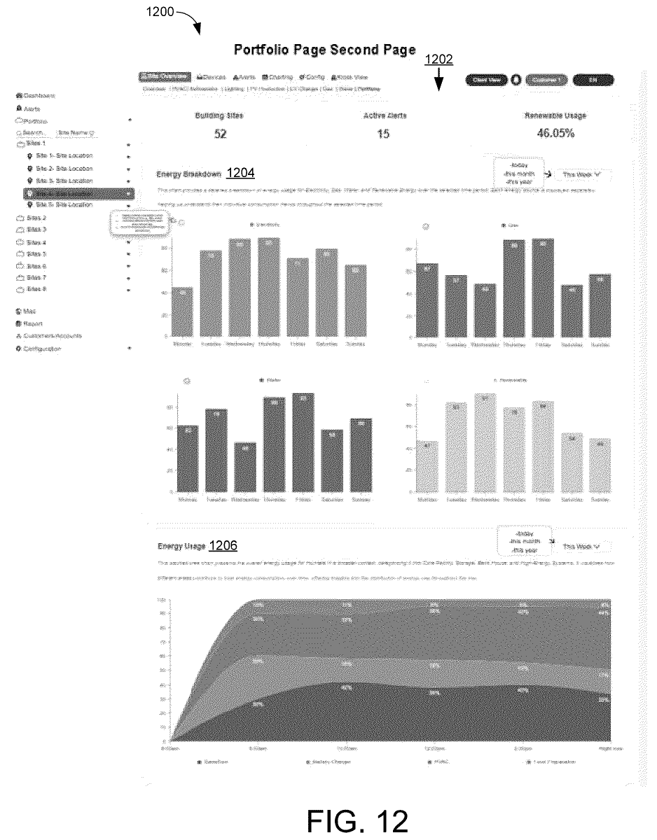

FIG. 12 depicts a Portfolio Page Second Page user interface 1200, according to some embodiments of the disclosed technologies. The Portfolio Page Second Page user interface 1200 includes multiple display elements. The display elements may include status display elements that indicate the values of parameters collected from multiple sites of the system, as well as the values of analytics generated by the system based on those parameters. The display elements may include control elements that enable an operator to control components of the system at multiple sites.

The Portfolio Page Second Page user interface 1200 may include display elements reflecting parameters and analytics aggregated for the multiple sites, at 1202. In the example of FIG. 12, these aggregate parameters and analytics include the number of building sites, the number of active alerts, and renewable energy usage as a percentage of total energy usage.

The Portfolio Page Second Page user interface 1200 may include display elements indicating an Energy Breakdown 1204. In the example of FIG. 12, the Energy Breakdown 1204 provides a breakdown of energy usage for all sites by energy usage for electricity, gas, water, and renewable energy over a selected period.

The Portfolio Page Second Page user interface 1200 may include display elements indicating Energy Usage 1206. In the example of FIG. 12, the Energy Usage 1206 provides a breakdown of energy usage for the salesfloor, battery charger, HVAC, and food preparation.

It should be understood that the above-described user interfaces are presented by way of example only. That is, these user interfaces present selected parameters, analytics and other information in particular arrangements according to particular settings. But these user interfaces may be customizable such that a user can specify other parameters, analytics, information, and arrangements.

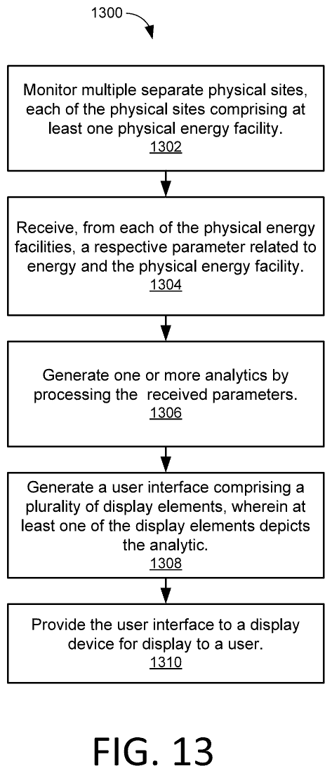

FIG. 13 is a flowchart illustrating a process 1300 for advanced energy management, according to some embodiments of the disclosed technologies. For example, the process 1300 may be performed by components of the advanced energy management systems of FIGS. 1-3. The elements of the process 1300 are presented in one arrangement. However, it should be understood that one or more elements of the process may be performed in a different order, in parallel, omitted entirely, and the like. Furthermore, the process 1300 may include other elements in addition to those presented. For example, the process 1300 may include error-handling functions if exceptions occur, and the like.

Referring to FIG. 13, the process 1300 may include monitoring multiple separate physical sites, each of the physical sites comprising at least one physical energy facility, at 1302. For example, the process 1300 may monitor the physical sites 102 of FIG. 1, each having at least one physical energy facility 104.

Referring again to FIG. 13, the process 1300 may include receiving, from each of the physical energy facilities, a respective parameter related to energy and the physical energy facility, at 1304. For example, the parameters may be related to the consumption, production, and/or storage of energy by the physical energy facility. For example, the parameters may include any of the parameters depicted in the user interfaces of FIGS. 4-12.

Referring again to FIG. 13, the process 1300 may include generating one or more analytics by processing the received parameter(s), at 1306. For example, the analytic(s) may include any of the analytics depicted in the user interfaces of FIGS. 4-12.

The process 1300 may generate a single analytic based on parameters from two or more of the physical sites. The analytic may combine parameters from multiple sites. For example, the KPIs 706 of FIG. 7 provide combined parameters representing multiple buildings. The analytic may compare the performance of two sites. The analytic may compare the performance of one site to one or more other sites. For example, one of the insights 508 of FIG. 5 indicates that the refrigeration units at this site (Site 4) consume 18% more energy than those at similar sites.

The analytic may predict a future value one or more analytics or parameters. For example, to generate the comparison 810 of FIG. 8 of actual water usage vs. predicted water usage, the system may predict water usage based on the last month's actual water usage.

Referring again to FIG. 13, the process 1300 may include generating a user interface comprising a plurality of display elements, wherein at least one of the display elements depicts the analytic, at 1308. For example, the process may generate any of the user interfaces of FIGS. 4-12.

Referring again to FIG. 13, the process 1300 may include providing the user interface to a display device for display to a user, at 1310. The user interface may be presented on the display 112 of the workstation 110 of the advanced energy management system 100 of FIG. 1. The user interface may be presented on the displays of the workstations 308 of the advanced energy management system 300 of FIG. 3.

In some embodiments, the process 1300 may include calculating analytics including amounts owed by subscribers to a community solar site. In these embodiments, the physical energy facility is a community solar site, and the parameters received from the community solar site include a measure of unused energy produced by the community solar site. Determining the amount owed by a subscriber may include processing the parameters received from the community solar site, the subscriber's share of energy production of the community solar site, and the subscriber's billing rate for the energy.

In some embodiments, inputs to the calculation may include Subscriber ID, Subscription Site, Subscription Size (% or kWh), Monthly Rate ($/kWh), Discount (%), Total Site Production (kWh), and Unused Energy (kWh)-specified by site owner monthly. The outputs may include a list of subscribers with the amounts owed for a given period. The amount owed may be calculated according to the following equation: Amount Owed =Monthly Rate*([% size of share*total site production] OR [kWh size of share]−[any amount not used])*[1-−% Discount].

As noted above, in some embodiments, the disclosed technologies may include the use of one or more trained machine learning models at one or more points in the described processes. Any machine learning models may be used. For example, the machine learning models and techniques may include classifiers, decision trees, neural networks, gradient boosting, and similar machine learning models and techniques.

The machine learning models may be trained previously according to historical correspondences between inputs and corresponding outputs. Once the machine learning models have been trained, new inputs may be applied to the trained machine learning model as inputs. In response, the machine learning models may provide the desired outputs.

Some embodiments include the training of the machine learning models. The training may be supervised, unsupervised, or a combination thereof, and may continue between operations for the lifetime of the system. The training may include creating a training set that includes the input parameters and corresponding assessments described above.

The training may include one or more second stages. A second stage may follow the training and use of the trained machine learning models, and may include creating a second training set, and training the trained machine learning models using the second training set. The second training set may include the inputs applied to the machine learning models, and the corresponding outputs generated by the machine learning models, during actual use of the machine learning models.

The second training stage may include identifying erroneous assessments generated by the machine learning model, and adding the identified erroneous assessments to the second training set. Creating the second training set may also include adding the inputs corresponding to the identified erroneous assessments to the second training set.

In some embodiments, artificial intelligence (AI) techniques may be applied in certain components of the advanced energy management system. For example, predictive energy management AI techniques for predicting energy consumption patterns may include Random Forest AI techniques. These techniques may achieve up to 92.5% accuracy for occupancy-based forecasting. Hybrid approaches may combine Long Short-Term Memory (LSTM) with Auto Encoder for superior performance.

Smart HVAC control AI techniques may include deep reinforcement learning, which excels at optimizing HVAC systems through direct interaction. XGBoost and LightGBM may be employed, and may achieve R-squared values of 0.978 for power usage prediction. These embodiments may reduce energy consumption by up to 15% while maintaining comfort.

Load prediction and demand response may employ transformer-based models, which outperform traditional algorithms in short-term load forecasting. Hybrid approaches may combine gated recurrent units (GRUs), temporal convolutional networks (TCNs), and attention mechanisms to capture long-term dependencies. A three-tier architecture may utilize cloud, fog, and edge computing for optimal processing. The system may connect to financial data to create financial analyses.

Occupancy analysis may employ convolutional neural networks (CNNs) such as Faster R-CNN with InceptionV 2. These embodiments may achieve over 98% accuracy for occupancy detection. Multi-modal fusion may combine environmental sensors with computer vision for enhanced accuracy. Edge computing architecture may enable real-time processing while maintaining privacy compliance.

Fault detection and diagnostics may employ Random Forest techniques. These embodiments may achieve 92.5% accuracy in fault detection. A combination of supervised and unsupervised learning models may be employed for comprehensive fault analysis. A real-time monitoring system enables early warning generation and predictive maintenance.

An ADR model may be employed for PV module efficiency. Model parameters may be obtained from IEC 61853 matrix measurements. PV system DC output may be simulated using module efficiency modeling. Fast simulation of PV performance may be employed, starting from PVsyst parameters.

The advanced energy management system may satisfy strict performance requirements. For example, the system may provide a response time of less than 2 seconds for user interactions. The system may be scalable to support over 10,000 concurrent users. The system availability may be 99.9% uptime (SLA-compliant). The system may provide real-time data updates every 5 seconds.

The advanced energy management system may include a robust security implementation. Authentication may feature OAuth 2.0 with RBAC. Data protection may feature AES-256 encryption (in transit/at rest). The security implementation may be compliance with GDPR, ISO 27001, and regular third-party audits.

The advanced energy management system may include one or more of the data management features that follow. Storage may feature a time-series database (e.g., InfluxDB) for historical data. Processing may feature a real-time pipeline with Apache Kafka and automated data validation. Backup features may include daily encrypted backups with geo-redundancy.

Solar photovoltaic (PV) Integration may include monitoring and analytics. The monitoring may include real-time metrics, inverter tracking, and fault detection. The analytics may include weather correlation, historical performance, and string-level diagnostics.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as effective as possible under the given circumstances, or making or achieving performance better than that which can be achieved with other settings or parameters.

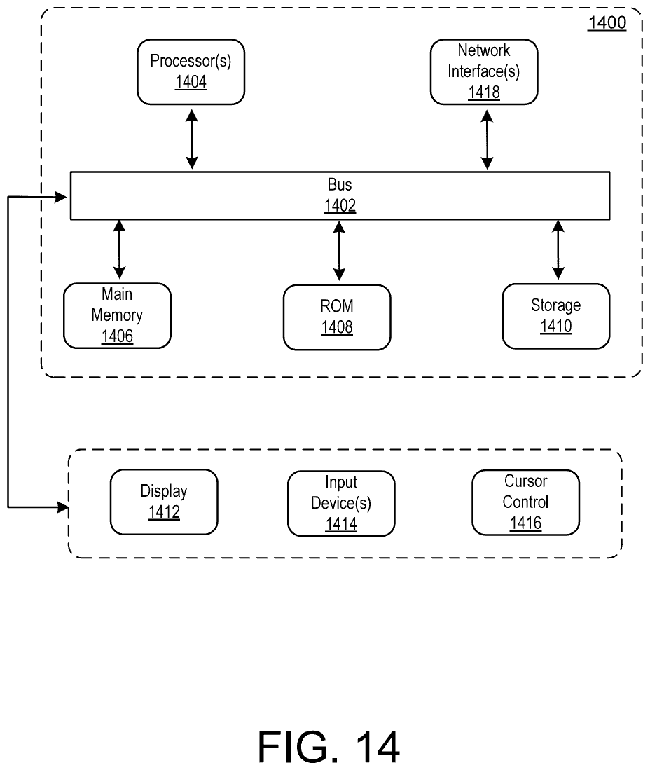

FIG. 14 depicts a block diagram of an example computer system 1400 in which embodiments described herein may be implemented. The computer system 1400 includes a bus 1402 or other communication mechanism for communicating information, one or more hardware processors 1404 coupled with bus 1402 for processing information. Hardware processor(s) 1404 may be, for example, one or more general purpose microprocessors.

The computer system 1400 also includes a main memory 1406, such as a random access memory (RAM), cache and/or other dynamic storage devices, coupled to bus 1402 for storing information and instructions to be executed by processor 1404. Main memory 1406 also may be used for storing temporary variables or other intermediate information during execution of instructions to be executed by processor 1404. Such instructions, when stored in storage media accessible to processor 1404, render computer system 1400 into a special-purpose machine that is customized to perform the operations specified in the instructions.

The computer system 1400 further includes a read only memory (ROM) 1408 or other static storage device coupled to bus 1402 for storing static information and instructions for processor 1404. A storage device 1410, such as a magnetic disk, optical disk, or USB thumb drive (Flash drive), etc., is provided and coupled to bus 1402 for storing information and instructions.

The computer system 1400 may be coupled via bus 1402 to a display 1412, such as a liquid crystal display (LCD) (or touch screen), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. In some embodiments, the same direction information and command selections as cursor control may be implemented via receiving touches on a touch screen without a cursor.

The computing system 1400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided or encoded on a computer readable or machine readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor(s) 1404 executing one or more sequences of one or more instructions contained in main memory 1406. Such instructions may be read into main memory 1406 from another storage medium, such as storage device 1410. Execution of the sequences of instructions contained in main memory 1406 causes processor(s) 1404 to perform the process steps described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 1410. Volatile media includes dynamic memory, such as main memory 1406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1402. Transmission media can also take the form of acoustic or light waves, such as those generated during radio-wave and infrared data communications.

The computer system 1400 also includes a communication interface 1418 coupled to bus 1402. Network interface 1418 provides a two-way data communication coupling to one or more network links that are connected to one or more local networks. For example, communication interface 1418 may be an integrated services digital network (ISDN) card, cable modem, satellite modem, or a modem to provide a data communication connection to a corresponding type of telephone line. As another example, network interface 1418 may be a local area network (LAN) card to provide a data communication connection to a compatible LAN (or a WAN component to communicate with a WAN). Wireless links may also be implemented. In any such implementation, network interface 1418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through communication interface 1418, which carry the digital data to and from computer system 1400, are example forms of transmission media.

The computer system 1400 can send messages and receive data, including program code, through the network(s), network link and communication interface 1418. In the Internet example, a server might transmit a requested code for an application program through the Internet, the ISP, the local network and the communication interface 1418.

The received code may be executed by processor 1404 as it is received, and/or stored in storage device 1410, or other non-volatile storage for later execution.

Each of the processes, methods, and algorithms described in the preceding sections may be embodied in, and fully or partially automated by, code components executed by one or more computer systems or computer processors comprising computer hardware. For example, a method bay be referred to as a “computer-implemented” method. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalents.

What is claimed is:

1. A system, comprising:
one or more hardware processors; and
one or more non-transitory machine-readable storage media encoded with instructions that, when executed by the one or more hardware processors, cause the system to perform operations comprising:
monitoring multiple separate physical sites, each of the physical sites comprising at least one physical energy facility engaged in the consumption of energy;
receiving, from each of the physical energy facilities, a respective parameter related to the consumption of the energy by the physical energy facility;
generating a first analytic by processing parameters received from the physical energy facilities of two or more of the physical sites;
generating a first user interface comprising a plurality of first display elements, wherein at least one of the first display elements depicts the first analytic; and
providing the first user interface to a display device for display to a user.

2. The system of claim 1, wherein a first one of the physical energy facilities is engaged in the production of energy, the operations further comprising:
receiving, from the first one of the physical energy facilities, a parameter related to the production of energy by the first one of the physical energy facilities;
generating a second analytic by processing the parameters received from the first one of the physical energy facilities;
generating a second user interface comprising a plurality of second display elements, wherein at least one of the second display elements depicts the second analytic; and
providing the second user interface to the display device for display to the user.

3. The system of claim 2, wherein a second one of the physical energy facilities is engaged in the storage of energy, the operations further comprising:
receiving, from the second one of the physical energy facilities, a parameter related to the storage of energy by the second one of the physical energy facilities;
generating a third analytic by processing the parameters received from the second one of the physical energy facilities;
generating a third user interface comprising a plurality of third display elements, wherein at least one of the third display elements depicts the third analytic; and
providing the third user interface to the display device for display to the user.

4. The system of claim 3, the operations further comprising:
generating a fourth analytic by processing one of the parameters, wherein the fourth analytic predicts a future value of the one of the parameters;
generating a fourth user interface comprising a plurality of fourth display elements, wherein at least one of the fourth display elements depicts the fourth analytic; and
providing the fourth user interface to the display device for display to the user.

5. The system of claim 1, the operations further comprising:
receiving one of the parameters from a gateway connected to one of the physical energy facilities over a wireless network connection.

6. The system of claim 5, wherein:
the gateway is implemented using at least one Raspberry Pi.

7. The system of claim 5, wherein:
the wireless network connection is implemented as a LoRaWAN (Long Range Wide Area Network).

8. The system of claim 2, wherein:
the first one of the physical energy facilities is a community solar site;
the parameters received from the community solar site comprise a measure of unused energy produced by the community solar site;
the second analytic represents an amount owed by a first subscriber to the community solar site; and
generating the second analytic comprises processing the parameters received from the community solar site, the first subscriber's share of energy production of the community solar site, and the first subscriber's billing rate for the energy.

9. One or more non-transitory machine-readable storage media encoded with instructions that, when executed by one or more hardware processors of a computing system, cause the computing system to perform operations comprising:
monitoring multiple separate physical sites, each of the physical sites comprising at least one physical energy facility engaged in the consumption of energy;
receiving, from each of the physical energy facilities, a respective parameter related to the consumption of the energy by the physical energy facility;
generating a first analytic by processing parameters received from the physical energy facilities of two or more of the physical sites;
generating a first user interface comprising a plurality of first display elements, wherein at least one of the first display elements depicts the first analytic; and
providing the first user interface to a display device for display to a user.

10. The one or more non-transitory machine-readable storage media of claim 9, wherein a first one of the physical energy facilities is engaged in the production of energy, the operations further comprising:
receiving, from the first one of the physical energy facilities, a parameter related to the production of energy by the first one of the physical energy facilities;
generating a second analytic by processing the parameters received from the first one of the physical energy facilities;
generating a second user interface comprising a plurality of second display elements, wherein at least one of the second display elements depicts the second analytic; and
providing the second user interface to the display device for display to the user.

11. The one or more non-transitory machine-readable storage media of claim 10, wherein a second one of the physical energy facilities is engaged in the storage of energy, the operations further comprising:
receiving, from the second one of the physical energy facilities, a parameter related to the storage of energy by the second one of the physical energy facilities;
generating a third analytic by processing the parameters received from the second one of the physical energy facilities;
generating a third user interface comprising a plurality of third display elements, wherein at least one of the third display elements depicts the third analytic; and
providing the third user interface to the display device for display to the user.

12. The one or more non-transitory machine-readable storage media of claim 11, the operations further comprising:
generating a fourth analytic by processing one of the parameters, wherein the fourth analytic predicts a future value of the one of the parameters;
generating a fourth user interface comprising a plurality of fourth display elements, wherein at least one of the fourth display elements depicts the fourth analytic; and
providing the fourth user interface to the display device for display to the user.

13. The one or more non-transitory machine-readable storage media of claim 9, the operations further comprising:
receiving one of the parameters from a gateway connected to one of the physical energy facilities over a wireless network connection.

14. The one or more non-transitory machine-readable storage media of claim 13, wherein:
the gateway is implemented using at least one Raspberry Pi.

15. The one or more non-transitory machine-readable storage media of claim 13, wherein:
the wireless network connection is implemented as a LoRaWAN (Long Range Wide Area Network).

16. The one or more non-transitory machine-readable storage media of claim 10, wherein:
the first one of the physical energy facilities is a community solar site;
the parameters received from the community solar site comprise a measure of unused energy produced by the community solar site;
the second analytic represents an amount owed by a first subscriber to the community solar site; and
generating the second analytic comprises processing the parameters received from the community solar site, the first subscriber's share of energy production of the community solar site, and the first subscriber's billing rate for the energy.

17. A computer-implemented method, comprising:
monitoring multiple separate physical sites, each of the physical sites comprising at least one physical energy facility engaged in the consumption of energy;
receiving, from each of the physical energy facilities, a respective parameter related to the consumption of the energy by the physical energy facility;
generating a first analytic by processing parameters received from the physical energy facilities of two or more of the physical sites;
generating a first user interface comprising a plurality of first display elements, wherein at least one of the first display elements depicts the first analytic; and
providing the first user interface to a display device for display to a user.

18. The computer-implemented method of claim 17, wherein a first one of the physical energy facilities is engaged in the production of energy, further comprising:
receiving, from the first one of the physical energy facilities, a parameter related to the production of energy by the first one of the physical energy facilities;
generating a second analytic by processing the parameters received from the first one of the physical energy facilities;
generating a second user interface comprising a plurality of second display elements, wherein at least one of the second display elements depicts the second analytic; and
providing the second user interface to the display device for display to the user.

19. The computer-implemented method of claim 18, wherein a second one of the physical energy facilities is engaged in the storage of energy, further comprising:
receiving, from the second one of the physical energy facilities, a parameter related to the storage of energy by the second one of the physical energy facilities;
generating a third analytic by processing the parameters received from the second one of the physical energy facilities;
generating a third user interface comprising a plurality of third display elements, wherein at least one of the third display elements depicts the third analytic; and
providing the third user interface to the display device for display to the user.

20. The computer-implemented method of claim 19, further comprising:
generating a fourth analytic by processing one of the parameters, wherein the fourth analytic predicts a future value of the one of the parameters;
generating a fourth user interface comprising a plurality of fourth display elements, wherein at least one of the fourth display elements depicts the fourth analytic; and
providing the fourth user interface to the display device for display to the user.

21. The computer-implemented method of claim 17, further comprising:
receiving one of the parameters from a gateway connected to one of the physical energy facilities over a wireless network connection.

22. The computer-implemented method of claim 21, wherein:
the gateway is implemented using at least one Raspberry Pi.

23. The computer-implemented method of claim 21, wherein:
the wireless network connection is implemented as a LoRaWAN (Long Range Wide Area Network).

24. The computer-implemented method of claim 18, wherein:
the first one of the physical energy facilities is a community solar site;
the parameters received from the community solar site comprise a measure of unused energy produced by the community solar site;
the second analytic represents an amount owed by a first subscriber to the community solar site; and
generating the second analytic comprises processing the parameters received from the community solar site, the first subscriber's share of energy production of the community solar site, and the first subscriber's billing rate for the energy.
